(19) United States
(12) Patent Application Publication
(10) Pub. No.: US 2024/0426263 A1
(43) Pub. Date: Dec. 26, 2024

(54) METHOD, SYSTEM, AND APPARATUS FOR OPTIMIZING CARBURETORS

(71) Applicants: Joseph Anthony Ternus, Clutier, IA (US); Lucas Dean Finley, State Center, IA (US)

(72) Inventors: Joseph Anthony Ternus, Clutier, IA (US); Lucas Dean Finley, State Center, IA (US)

(21) Appl. No.: 18/751,195

(22) Filed: Jun. 22, 2024

Related U.S. Application Data
(60) Provisional application No. 63/509,736, filed on Jun. 22, 2023.

(51) Int. Cl. F02M 19/01; F02D 35/00; F02M 7/17

(52) U.S. Cl. CPC F02M 19/01; F02D 35/0053; F02M 7/17; F02D 2400/16

(57) ABSTRACT

A system of optimizing carburetor operation comprising: a carburetor controller; an air-fuel ratio sensor; a first communication channel; a processor; a power source; a non-transitory computer-readable memory element; a second communication channel for transmitting and receiving data; an external device; wherein said sensor sample air-fuel ratio in said carburetor; said sensor send said air-fuel ratio information via said first communication channel to said processor; said processor store it in said non-transitory computer-readable memory element; and said processor also send said information to said external device via said second communication channel. A carburetor spacer apparatus with multiple ports is also presented.

This application is a continuation application of U.S. Provisional Application No. 63/509,736, filed Jun. 22, 2023, and incorporates by reference the disclosure therein.

### FIELD OF INVENTION

The present invention relates to methods, systems, and apparatus for optimizing carburetors.

### BACKGROUND OF INVENTION

The invention is particularly useful with respect to enhancing engine performance, efficiency, and monitoring capabilities. It offers a comprehensive range of functionalities that enable efficient data management. By directly receiving engine health data from sensors, the device assumes control over the idle air control valve while simultaneously displaying and logging the engine health data. This data can be conveniently transmitted wirelessly to a phone, tablet, or computer. Through the implementation of this stand-alone controller, adjustments to the idle air control valve can be effortlessly made, providing dynamic control over a static device such as a carburetor. Consequently, the engine can operate with improved efficiency and achieve heightened performance levels. Additionally, the device facilitates seamless wireless transmission and reception of engine health information to the user's device, enabling data display, data logging, and idle air control valve adjustments. The logged data can be conveniently stored on the device itself or seamlessly sent to the cloud for further processing. This invaluable information serves to determine service requirements, evaluate engine health, and assess fuel quality. To simplify the installation process of the idle air control valve and manifold pressure sensor, a dual port carburetor spacer is employed. These carburetor spacers guarantee equal pressure distribution within the intake manifold, thereby providing two sources for either air injection or receiving vacuum pressure for various sensors or control devices such as transmission controllers, PCV valves, and cruise control devices. The utilization of carburetor spacers represents a practical solution when the factory-installed carburetors lack sufficient ports, thereby eliminating the need for drilling and tapping additional holes. Importantly, each of these systems is capable of functioning independently, without requiring interdependence on one another.

The invention is also useful with respect to carburetor tuning, transforming it from an art form into a scientific endeavor. It offers comprehensive information without compromising the aesthetic appeal of classic vehicles or burdening compact units like generators with additional gauges. Its compatibility extends to all carbureted engine sizes, ranging from large tractor engines to small weed whacker engines.

Many techniques are known for tuning carburetors using expensive monitoring equipment, which require training and expertise not readily available to a layperson at home.

One common issue that arises when attempting to learn carburetor tuning without a feedback mechanism is the potential for challenges such as fuel ratio inconsistencies while driving carbureted vehicles across various terrains or the accumulation of fuel residue during prolonged periods of inactivity.

The present invention effectively addresses these challenges, empowering users to finely tune their carbureted engines, receive warnings about potential vehicle issues, and even detect subpar fuel quality. In doing so, it effectively safeguards more expensive engines from potential damage. Once the initial setup is complete, the control device can operate independently without requiring any wireless device applications.

Moreover, if the sole objective is to display and log engine health data, the installation of the idle air control valve is not mandatory. Although the dual port spacer significantly simplifies the installation process of the control device, it remains an optional component. For those seeking additional vacuum ports or enhanced carburetor insulation from engine heat, the dual port spacer can be installed even without the control device.

### SUMMARY OF THE INVENTION

This summary is intended to disclose the present invention, a method, system, and apparatus for optimizing carburetor operation. The embodiments and descriptions are used to illustrate the invention and its utility and are not intended to limit the invention or its use. An object of the present invention is to provide a method, a system, and an apparatus, for optimizing carburetor operation in a manner having advantages in one or more of the above respects.

A system of optimizing carburetor operation comprising: A carburetor controller; a power source; an air-fuel ratio sensor; a first communication channel; a processor; a non-transitory computer-readable memory element; a second communication channel for transmitting and receiving data; an external device; characterized in that the sensor sample air-fuel ratio in the carburetor; the sensor send the air-fuel ratio information via the first communication channel to the processor; the processor store it in the non-transitory computer-readable memory element; and the processor also send the information to the external device via the second communication channel.

Some described embodiments include at least one pressure sensor. In the example the pressure sensor collects vacuum measurements from the carburetor intake chambers. The information may be used for display, analysis and tuning the carburetor. Other described embodiments include pressure valve to allow the present invention to control and adjust the pressure level. More embodiments include carburetor spacer to simplify the process of measuring and adjusting the vacuum level.

Furthermore, additional described embodiments include the inclusion of a tachometer for gathering revolution information. This valuable data, when combined with the vacuum information, can be utilized to analyze fuel quality, develop dynamic engine operation profiles, and optimize overall engine performance.

An apparatus is disclosed that comprises a carburetor spacer with two vacuum ports, wherein both ports are connected to the intake chamber of the manifold. Certain embodiments also incorporate a heat insulation element to shield the carburetor from engine heat. In other variations, the carburetor spacer apparatus is constructed using thermal insulation materials. Additional embodiments introduce a directional opening in the carburetor spacer apparatus, facilitating the creation of an air swirl for improved fuel atomization.

The invention proves particularly beneficial for optimizing the operation of carburetors in classic vehicles. Consider the scenario of a devoted car enthusiast working on a completely original 1966 Mustang. Preserving the interior of the Mustang is of utmost importance, meaning that no alterations or additions of extra controls and gauges can be made to the car's interior. In order to enhance the carburetor's performance, the car enthusiast installs a controller, in accordance with the present invention, onto the carburetor using a dual port spacer apparatus. Subsequently, the enthusiast downloads the corresponding controller application onto her wireless device and establishes a connection with the controller. Once the connection is established, she can drive the vehicle while collecting data on the carburetor and engine performance. Upon returning, she uploads the data to the cloud for immediate feedback on the carburetor setup. She then shares this data with a carburetor expert for verification. After the carburetor settings have been verified, she enables the idle air control valve, allowing the valve to rectify any anomalies that may arise with the carburetor.

Moreover, the invention proves particularly beneficial for troubleshooting carburetor issues in classic vehicles. For instance, consider the scenario of a granddaughter inheriting her grandparents' 1956 Ford truck. The vehicle has been sitting idle for 10 years, and upon attempting to drive it, the granddaughter discovers that it does not run correctly. In order to diagnose and troubleshoot the cause of the vehicle's poor performance, the granddaughter installs a controller, in accordance with the present invention, with a pressure sensor connected to the dual port spacer apparatus of the carburetor. The granddaughter proceeds to download the corresponding controller application onto her wireless device and establishes a connection with the controller. With the connection established, she drives the vehicle while collecting data on the carburetor and engine performance. After completing the drive, she uploads the collected data to the cloud for analysis. Utilizing data visualization provided by the application, she observes a graph indicating that one of the pressure activated circuits on the carburetor is not functioning correctly. Based on this information, the granddaughter determines that a specific part of the carburetor needs to be replaced. After replacing the defective part, she conducts further testing and verifies that the changes have rectified the malfunctioning carburetor circuits. As a result, she is able to enjoy driving her grandparent's vehicle with restored performance and functionality.

Additionally, the invention proves particularly beneficial for improving efficiency in carbureted engines. For example, consider the scenario of a homeowner relying on a small gasoline generator during extended power outages caused by storm damage. Since gasoline availability is typically limited during such situations, maximizing generator efficiency becomes crucial. To enhance the efficiency of the generator, the homeowner installs a controller and pressure sensor, in accordance with the present invention, onto the carburetor utilizing pre-existing vacuum ports. Subsequently, the homeowner downloads the corresponding controller application onto their wireless device and establishes a connection with the controller. Once the connection is established, they configure and enable the idle air control valve, which allows the device to rectify any anomalies that may arise with the carburetor, ensuring that it always operates at peak efficiency. Moreover, the homeowner can live view and log the vacuum pressure and engine performance through the application. This functionality allows them to monitor the load on the engine in real-time, ensuring optimal performance, as well as assess the fuel quality for compatibility with the system. By leveraging the features provided by the invention, the homeowner can effectively manage and optimize the generator's efficiency, even when gasoline supplies are limited. The ability to remotely monitor and adjust the carburetor's performance in real-time allows for immediate response to any deviations and enables the generator to operate at its highest efficiency levels. Consequently, the homeowner can maximize the power output and minimize fuel consumption, resulting in extended operation times during critical power outages.

Furthermore, the invention proves particularly beneficial for verifying engine settings on carbureted engines that are used infrequently. For instance, consider a business owner operating a lawn care business in northern Minnesota. To ensure consistent performance year after year, the business owner installs a controller, in accordance with the present invention, onto the carburetor using a dual port spacer apparatus, tachometer sensor, and pressure sensor. Subsequently, the business owner downloads the corresponding controller application onto their wireless device and establishes a connection with the controller. Once connected, they log their mower data during the peak season and observe that everything is running correctly. The data log is uploaded to the cloud for storage and reference. Throughout the year, the business owner continues to use the mower for various jobs. After the long winter, when the business owner starts mowing again, they notice a decline in performance compared to the previous year. To diagnose and rectify the issue, they connect to the controller and data-log the mower once more. By comparing the new data log with the stored log from the previous year, they identify that the governor on the engine is running 500 rpm lower than last year. Using the live feedback provided by the wireless device, the business owner adjusts the governor, ensuring it reaches the peak operating rpm. With the engine properly tuned, they are able to resume mowing with optimal performance. Through the implementation of the present invention, the business owner can easily verify and adjust the engine settings on carbureted engines that experience periods of infrequent use. The ability to data-log and compare performance data over time facilitates the identification of any deviations or issues, allowing for prompt adjustments and maintenance. As a result, the business owner can ensure that the engine operates at its peak efficiency and performance levels, delivering reliable and consistent results year after year.

One preferred embodiment of the invention proves particularly beneficial for enhancing the performance of carbureted engines used in mountainous areas. Consider the scenario of a large grain truck being used on a farm located in a mountainous region. The truck's reliability is affected by the thinner air at higher altitudes. To address this issue and provide the carburetor with dynamic performance, the farmer installs a controller, in accordance with the present invention, onto the carburetor using a dual port spacer apparatus and a pressure sensor. Subsequently, the farmer downloads the corresponding controller application onto their wireless device and establishes a connection with the controller. Once the connection is established, they can verify and adjust the carburetor settings at their farm located at a lower altitude. By collecting data and performing analyses, they can optimize the carburetor for optimal performance under normal conditions. After uploading the data log to the cloud and verifying the carburetor settings, the farmer enables the idle air control valve. As the truck drives up into the mountains where the air becomes thinner, the idle air control valve progressively opens, injecting additional air into the system. This adjustment ensures that the engine maintains an optimal air-fuel ratio, compensating for the higher altitudes and enabling the engine to operate efficiently even in challenging mountainous terrain. Through the implementation of the present invention, the farmer can effectively enhance the performance of the carbureted engine in the large grain truck when operating in mountainous areas. By dynamically adjusting the carburetor settings and utilizing the idle air control valve, the engine can maintain optimal air-fuel ratios, resulting in consistent performance and reliability at varying altitudes. Integrating the invention into the carburetor system enables the farmer to overcome the challenges posed by high-altitude environments, ensuring the truck operates at peak efficiency regardless of the thin air conditions. This improved performance contributes to increased productivity and reliability in farm operations conducted in mountainous regions.

Another preferred embodiment of the present invention describes troubleshooting carburetor issues encountered during long road trips. Consider the scenario of a car enthusiast embarking on a journey from Florida to Texas in their original 1957 Chevy. Midway through the trip, the engine starts to experience frequent stalling at stop signs, and it only restarts after cooling down. To diagnose and address the issue, the car enthusiast installs a controller, in accordance with the present invention, onto the carburetor. After data-logging the car during instances of engine failure, the enthusiast uploads the collected data to the cloud and shares it on a popular car forum online. The helpful community members on the forum analyze the data and identify that a vapor lock issue is occurring due to the carburetor becoming excessively warm, causing the fuel to boil and turn into vapor. Recognizing this problem, the enthusiast proceeds to install the insulative dual port spacer apparatus beneath the carburetor. By incorporating this insulative spacer apparatus, the carburetor is effectively shielded from the engine's heat, preventing the fuel from reaching its boiling point and vaporizing. This insulation allows the fuel to remain in a liquid state, ensuring a consistent fuel supply to the engine and preventing vapor lock occurrences. Through the implementation of the present invention, car enthusiasts and drivers can troubleshoot, and address carburetor issues experienced during long road trips. By utilizing the controller, data logging capabilities, and cloud connectivity, individuals can collect and share valuable information to diagnose problems effectively. The installation of the insulative dual port spacer apparatus offers a practical solution to prevent vapor lock, ensuring the smooth operation of the engine and enhancing the overall reliability of classic vehicles during extended journeys. Integrating the present invention into the carburetor system empowers car enthusiasts to maintain optimal performance and address issues promptly, ensuring an enjoyable and trouble-free driving experience.

Yet another preferred embodiment of the present invention describes a system for alerting when issues arise in carbureted engines. Consider the scenario of a large power generator used by a food distributor to support a freezer crucial for storing perishable goods. The uninterrupted operation of the generator is vital as a power outage could result in the freezer thawing within a matter of hours. To address this critical issue and ensure dynamic performance of the carburetor based on weather conditions, the facilities manager installs a controller, in accordance with the present invention, onto the carburetor using a dual port spacer apparatus, a pressure sensor, and a fuel quality sensor. Subsequently, the business owner, facilities manager, and maintenance manager download the corresponding controller application onto their wireless devices and establish connections with the controller. Once connected, they receive timely notifications of any fuel quality issues detected, such as the presence of water or deterioration of the fuel. These notifications enable proactive measures to be taken to address fuel-related problems promptly, ensuring the reliable operation of the generator. In addition to fuel quality alerts, the controller application also provides reminders at predefined intervals to perform maintenance tasks on the generator, ensuring that it remains in peak operating condition. These reminders help the facility's staff adhere to maintenance schedules and perform necessary maintenance tasks to optimize the generator's performance and longevity. Furthermore, the system can send notifications when the generator kicks on during the night, alerting the relevant personnel to the operational status. This real-time feedback allows for immediate awareness and response to any unexpected generator activity. Moreover, the controller's capabilities extend to monitoring the generator's load levels and performance. If the load exceeds safe operating limits or if the generator is running poorly, notifications are sent to the appropriate individuals, enabling them to take corrective actions promptly and prevent any potential damage or disruptions. The invention also accounts for specific seasonal conditions, such as power outages occurring during winter or summer. By incorporating the idle air control valve into the system, the carburetor's air-fuel mixture can be dynamically adjusted to accommodate the changing environmental conditions. This feature ensures optimal engine performance, compensating for temperature variations and altitude changes, and mitigating the risk of engine malfunctions during critical periods. Through the integration of the present invention, the facility's staff can receive important reminders and notifications regarding the generator's fuel quality, maintenance requirements, operational status, load levels, and overall performance. This comprehensive feedback system empowers them to proactively address any issues, optimize the generator's performance, and ensure the uninterrupted operation of critical equipment during power outages and adverse weather conditions. Integrating the present invention into carbureted engines, particularly large power generators, enables effective monitoring, timely notifications, and dynamic adjustments for optimal performance, ultimately enhancing the reliability and efficiency of the generator in critical operational settings.

Still other preferred embodiment of the present invention describes a system for providing notifications to emergency crews in situations where a carbureted engine is crucial during emergencies. Consider the scenario of a large generator installed at a hospital, responsible for supplying power to critical life-saving equipment. In the event of a power outage, the generator plays a vital role in ensuring uninterrupted electricity supply to the essential medical devices. To enhance the safety and effectiveness of the generator in emergency situations, a system constructed according to the present invention sends notifications to emergency personnel. In the event of a power outage, the generator's controller is configured to detect the loss of power and promptly notify the relevant emergency personnel. This notification serves as an alert, informing the emergency crews that the generator has been activated and that immediate action may be required. Furthermore, the present invention extends its notification capabilities to include engine and generator health monitoring. By incorporating sensors and data logging functionalities, the controller collects and analyzes real-time data on the engine's performance and the generator's health. This includes monitoring crucial parameters such as fuel levels, temperature, pressure, and overall system health. In the event of an engine failure or any critical issues that prevent the generator from starting or operating properly, the controller triggers notifications to all emergency personnel in the immediate area. These notifications serve as an early warning system, allowing the emergency crews to respond swiftly and take appropriate measures to address the issue and restore the generator's functionality. By providing these notifications to emergency personnel, the invention ensures that the necessary steps can be taken promptly to rectify any problems with the generator, minimize downtime, and restore the power supply to the life-saving equipment within the hospital. Through the integration of the present invention, carbureted engines, particularly those used in critical settings such as hospitals, can effectively communicate with emergency crews. The notifications enable emergency personnel to be promptly alerted to power outages, engine failures, and any generator health issues, empowering them to respond quickly and ensure the continuous operation of life-saving equipment. Integrating the present invention into carbureted engines used in emergency scenarios offers enhanced safety, rapid response times, and improved reliability during critical situations. These features contribute to the overall effectiveness and efficiency of emergency response efforts, ultimately safeguarding the well-being of individuals who rely on the uninterrupted power supply provided by the carbureted engine.

Further features and advantages of the invention will be apparent from the description below.

### BRIEF DESCRIPTION OF THE DRAWINGS

The present invention is illustrated with 19 drawings on 19 sheets.

FIG. 1 is a block diagram of tuning a 1966 Mustang conducted in accordance with the invention.

FIG. 2 is a flow chart illustrating a method of implementing the system of FIG. 1.

FIG. 3 is a block diagram illustrating an engine tuning process of a classic truck, such as 1956 F100, in accordance with the present invention.

FIG. 4 is a flow chart illustrating a preferred method for implementing the system of FIG. 3.

The block diagram of FIG. 5 illustrates a system for operating and maintaining small generators in accordance with the present invention.

FIG. 6 is a flow chart illustrating a method of operation of the system shown in FIG. 5.

The diagram of FIG. 7 illustrates a system for maintaining and optimizing a sporadically used gasoline engine, such as a lawn mower, in accordance with the invention.

FIG. 8 is a flow chart illustrating a preferred method for implementing the system of FIG. 7.

The block diagram of FIG. 9 illustrates a method for enhancing the performance of carbureted engines in high altitude in accordance with the invention.

FIG. 10 is a flow chart illustrating a preferred method for implementing the system of FIG. 9.

The diagram of FIG. 11 illustrates a method for troubleshooting carburetor issues and mitigating engine heat effect in accordance with the invention.

FIG. 12 is a flow chart illustrating a preferred method for implementing the system of FIG. 11.

FIG. 13 is a block diagram illustrating a system, constructed in accordance with the present invention, for identifying and alerting when issues arise in carbureted engines.

FIG. 14 is a flow chart illustrating a preferred method for implementing the system of FIG. 13.

The diagram of FIG. 15 illustrates a system, constructed in accordance with the present invention, for providing notifications to emergency crews in situations where a carbureted engine is crucial during emergencies.

FIG. 16 is a flow chart illustrating a preferred method for implementing the system of FIG. 15.

### DETAILED DESCRIPTION OF THE DRAWINGS

The following descriptions are not meant to limit the invention, but rather to add to the summary of invention, and illustrate the present invention, by offering and illustrating various embodiments of the present invention, method, system, and apparatus for optimizing carburetors. While embodiments of the invention are illustrated and described, the embodiments herein do not represent all possible forms of the invention. Rather, the descriptions, illustrations, and embodiments are intended to teach and inform one skilled in the art without limiting the scope of the invention.

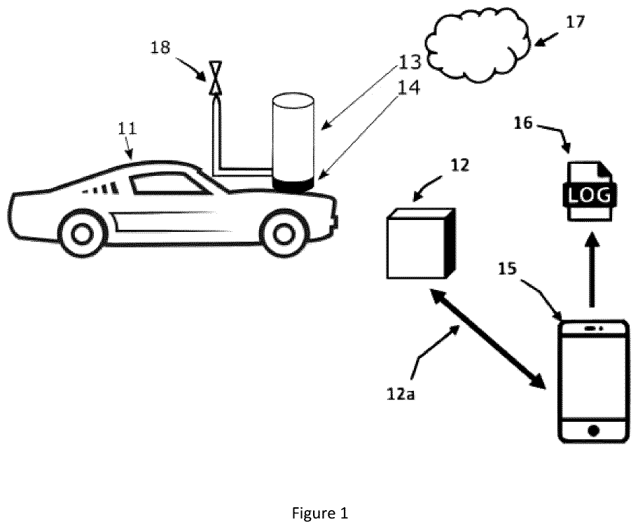

The block diagram of FIG. 1 illustrates one preferred embodiment wherein the system comprised of a dual port spacer 14 installed between carburetor 13 and the engine of a car 11. An idle air control valve 18 connected to one of the ports of the dual port spacer 14. A carburetor controller with sensor array 12 is connected to the idle air control valve 18 and engine health sensor array. The carburetor controller 12 also has a wireless communication 12a for communicating with wireless device 15 in order to collect engine data 16 and store the data at a cloud service 17. An application on wireless device 15 allows users to monitor, in real time, all the engine health sensor information.

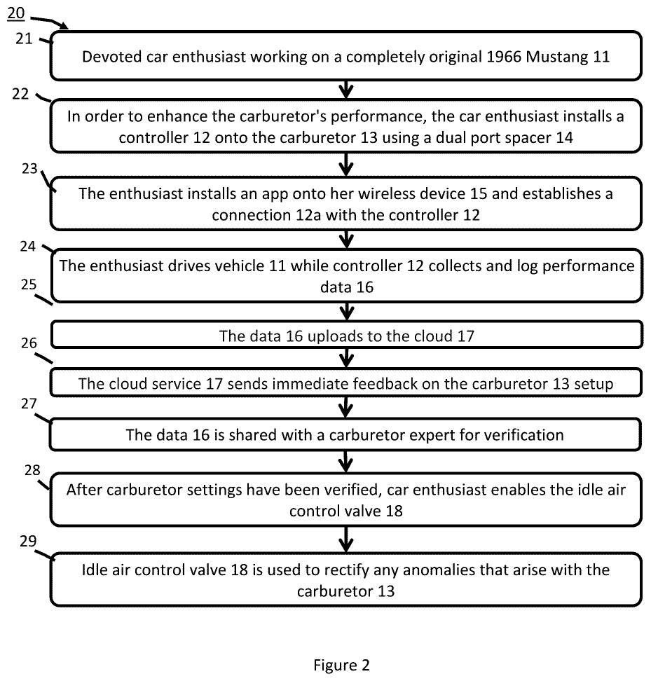

The flow chart in FIG. 2 illustrates one embodiment of the invention generally designated 20. In FIG. 2, a devoted car enthusiast is working on a completely original 1966 Mustang 11. In order to enhance the carburetor's performance, the car enthusiast installs a controller 12 onto the carburetor 13 using a dual port spacer 14. Later, the enthusiast installs an app onto her wireless device 15 and establishes a connection 12a with the controller 12. The vehicle driving while collecting performance data 16, during which, the data 16 is uploads to a cloud service 17. The cloud service 17 sends immediate feedback on the carburetor setup. The data 16 was then shared with a carburetor expert for verification. After the carburetor settings have been verified, she enables idle air control valve 18 to rectify any anomalies that arise with the carburetor 13.

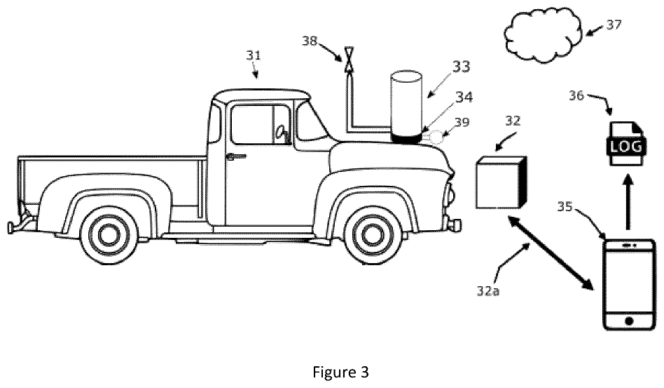

The block diagram of FIG. 3 illustrates another preferred embodiment wherein the system is comprised of a dual port spacer 34 installed between carburetor 33 and the engine of a truck 31. An idle air control valve 38 connected to one of the ports of the dual port spacer 34. A vacuum sensor 39 is connected to the second port on the dual port spacer 34. A carburetor controller with sensor array 32 is connected to the idle air control valve 38, vacuum sensor 39, and engine health sensor array. The carburetor controller 32 also has a wireless communication 32a for communicating with wireless device 35 in order to collect engine data 36 and store the data at a cloud service 37. An application on wireless device 35 allows users to monitor, in real time, all the engine health sensor information.

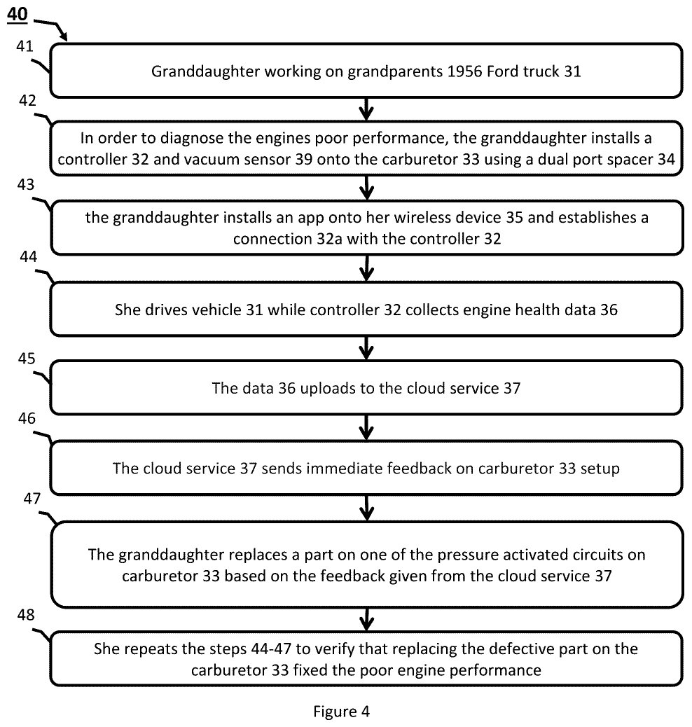

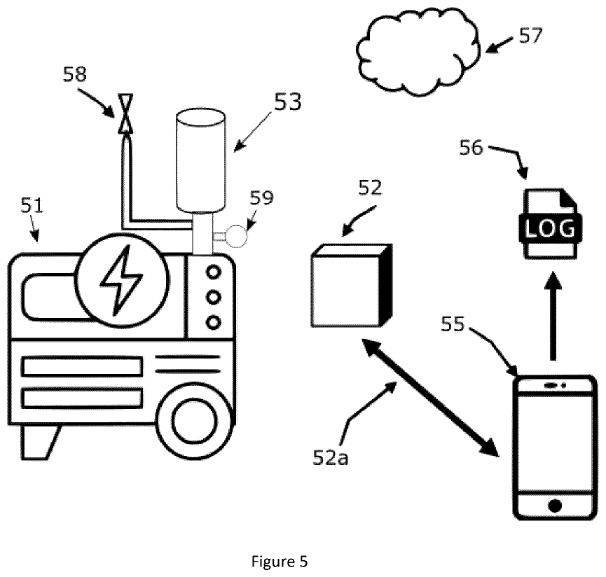

The flow chart in FIG. 4 illustrates one embodiment of the invention generally designated 40. In FIG. 4, a granddaughter is working on her grandparents 1956 Ford truck. In order to diagnose the engine's poor performance, the granddaughter installs controller 32 and vacuum sensor 39 onto the carburetor 33 using a dual port spacer 34. Later, the granddaughter installs an app onto her wireless device 35 and establishes a connection 32a with the controller 32. She drives vehicle 31 while controller 32 collects engine health data 36. The data 36 uploads to the cloud service 37. The cloud service 37 sends immediate feedback on carburetor 33 setup. The granddaughter replaces a part on one of the pressure activated circuits on carburetor 33 based on the feedback given from the cloud service 37.

The block diagram of FIG. 5 illustrates yet another preferred embodiment wherein the system is comprised of an idle air control valve 58 connected to one of the ports of the carburetor 53. Vacuum sensor 59 is connected to another vacuum port on the carburetor 53. A carburetor controller with sensor array 52 is connected to the idle air control valve 38, vacuum sensor 59, and engine health sensor array. The carburetor controller 52 also has a wireless communication 52a for communicating with wireless device 55 in order to collect engine data 56 and store the data at a cloud service 57. An application on wireless device 55 allows users to monitor, in real time, all the engine health sensor information.

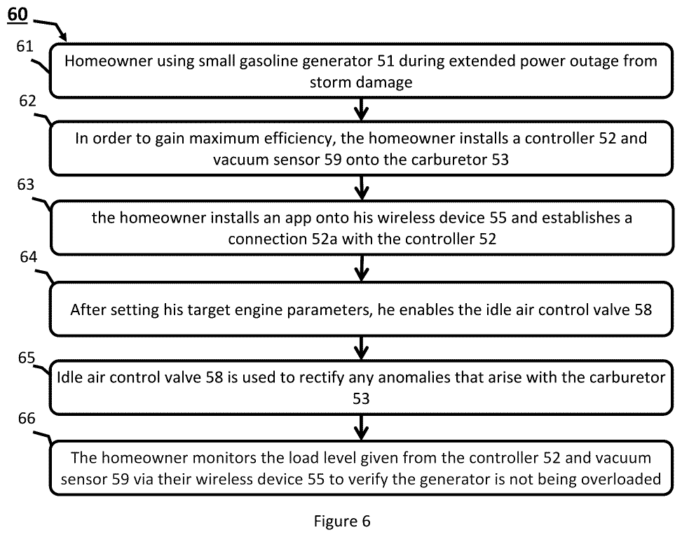

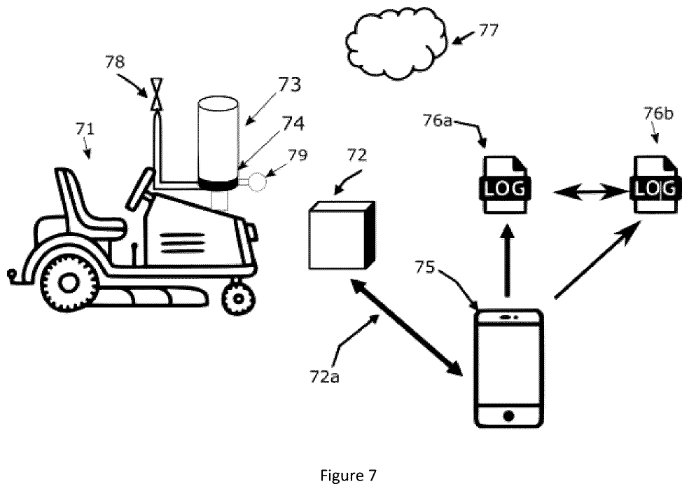

The flow chart in FIG. 6 illustrates one embodiment of the invention generally designated 60. In FIG. 6, a homeowner using small gasoline generator 51 during an extended power outage. In order to gain maximum efficiency, the homeowner installs a controller 52 and vacuum sensor 59 onto carburetor 53. Later, the homeowner installs an app onto his wireless device 55 and establishes a connection 52a with the controller 52. After setting the target engine parameters, he enables the idle air control valve 58. The idle air control valve 58 is used to rectify any anomalies that arise with the carburetor during the operation of the generator. The homeowner monitors the load level given from the controller 52 and vacuum sensor 59 via wireless device 55 to verify the generator is not being overloaded.

The block diagram of FIG. 7 illustrates more preferred embodiments wherein the system is comprised of a dual port spacer 74, installed between carburetor 73 and the engine of a lawn mower 71. An idle air control valve 78 connected to one of the ports of the dual port spacer 74. A vacuum sensor 79 is connected to the second port on the dual port spacer 74. A carburetor controller with sensor array 72 is connected to the idle air control valve 78, vacuum sensor 79, and engine health sensor array. The carburetor controller 72 also has a wireless communication 72a for communicating with wireless device 75 in order to collect engine data 76a and 76b and store the data at a cloud service 77. An application on wireless device 75 allows users to monitor, in real time, all the engine health sensor information.

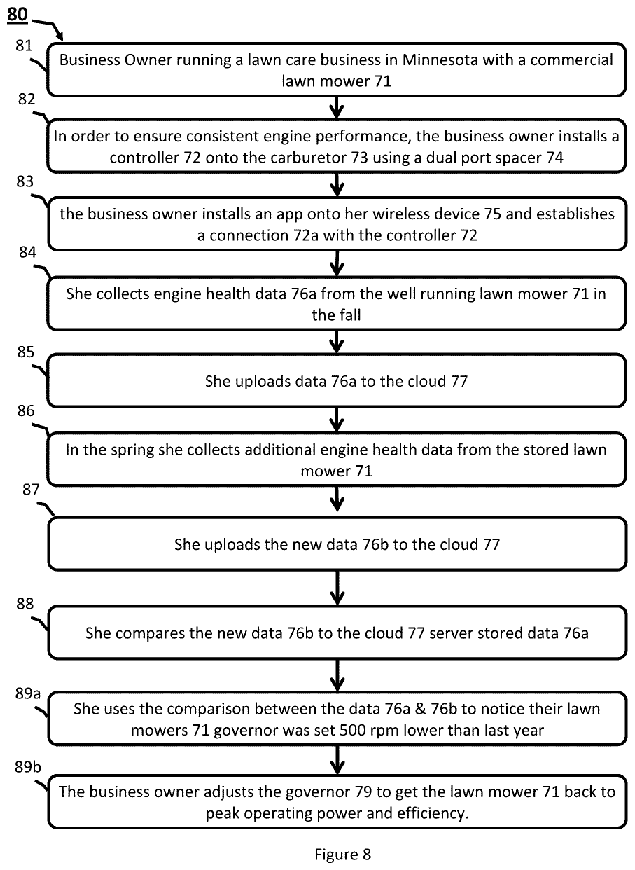

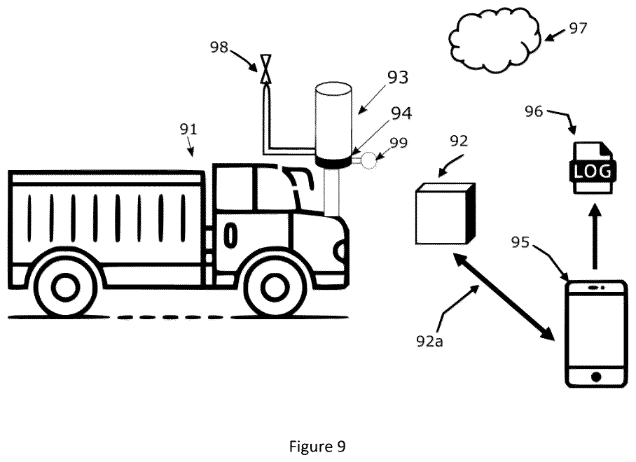

The flow chart in FIG. 8 illustrates one embodiment of the invention generally designated 80. In FIG. 8, a business owner is running a lawn care business in Minnesota with a commercial lawn mower 71. In order to ensure consistent engine performance, the business owner installs a controller 72 onto the carburetor 73 using a dual port spacer 74. Later, the business owner installs an app onto her wireless device 75 and establishes a connection 72a with the controller 72. In the fall she collects engine health data 76a from the well running lawn mower 71. She uploads that data 76a to cloud service 77. In the spring she collects additional engine health data from the same lawn mower 71. She uploads the new data 76b to cloud service 77 and then compares the new data 76b to cloud service 77 stored data 76a from last fall. She uses the comparison between the data 76a and 76b to notice her lawn mowers 71 governor was set 500 rpm lower than last year. The business owner adjusts the governor 79 to get the lawn mower 71 back to peak power and efficiency.

The block diagram of FIG. 9 illustrates still more preferred embodiments wherein the system is comprised of a dual port spacer 94 installed between carburetor 93 and the engine of a grain truck 91. An idle air control valve 98 connected to one of the ports of the dual port spacer 94. A vacuum sensor 99 is connected to the second port on the dual port spacer 94. A carburetor controller with sensor array 92 is connected to the idle air control valve 98, vacuum sensor 99, and engine health sensor array. The carburetor controller 92 also has a wireless communication 92a for communicating with wireless device 95 in order to collect engine data 36 and store the data at a cloud service 97. An application on wireless device 95 allows users to monitor, in real time, all the engine health sensor information.

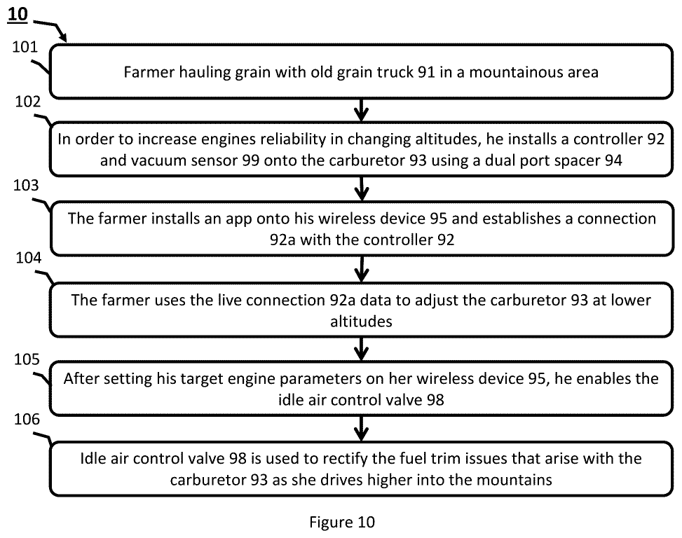

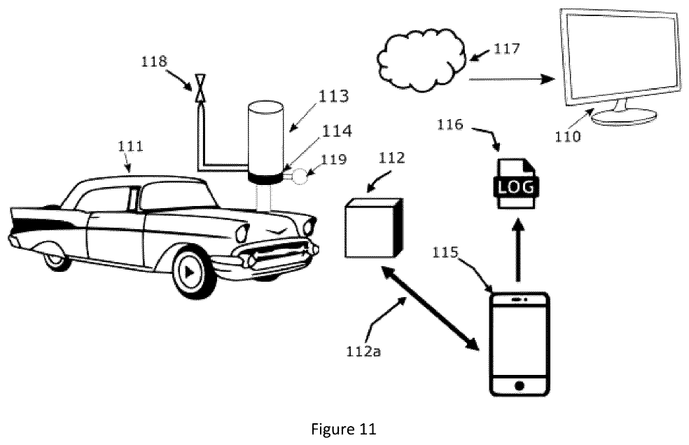

The flow chart in FIG. 10 illustrates an embodiment of the invention generally designated 100. In FIG. 10, a farmer is hauling grain in an old grain truck 91 in a mountainous area. In order to increase engine's reliability in changing altitudes, he installs a controller 92 and vacuum sensor 99 onto the carburetor 93 using a dual port spacer 94. Later, the farmer installs an app onto his wireless device 95 and establishes a connection 92a with the controller 92. The farmer uses the live connection 92a data to adjust the carburetor 93 at lower altitudes. After setting his target engine parameters on his wireless device 95, the farmer enables the idle air control valve 98. The Idle air control valve 98 is used to rectify the fuel trim issues that arise with the carburetor 93 as he drives higher into the mountains.

The block diagram of FIG. 11 illustrates yet another preferred embodiment wherein the system is comprised of a dual port spacer 114 installed between carburetor 113 and the engine of a 57 chevy 111. An idle air control valve 118 connected to one of the ports of the dual port spacer 114. A vacuum sensor 119 is connected to the second port on the dual port spacer 114. A carburetor controller with sensor array 112 is connected to the idle air control valve 118, vacuum sensor 119, and engine health sensor array. The carburetor controller 112 also has a wireless communication 112a for communicating with wireless device 115 in order to collect engine data 116 and store the data at a cloud service 117. An application on wireless device 115 allows users to monitor, in real time, all the engine health sensor information. Engine data 116 can be shared through cloud service 117 to an online forum 110.

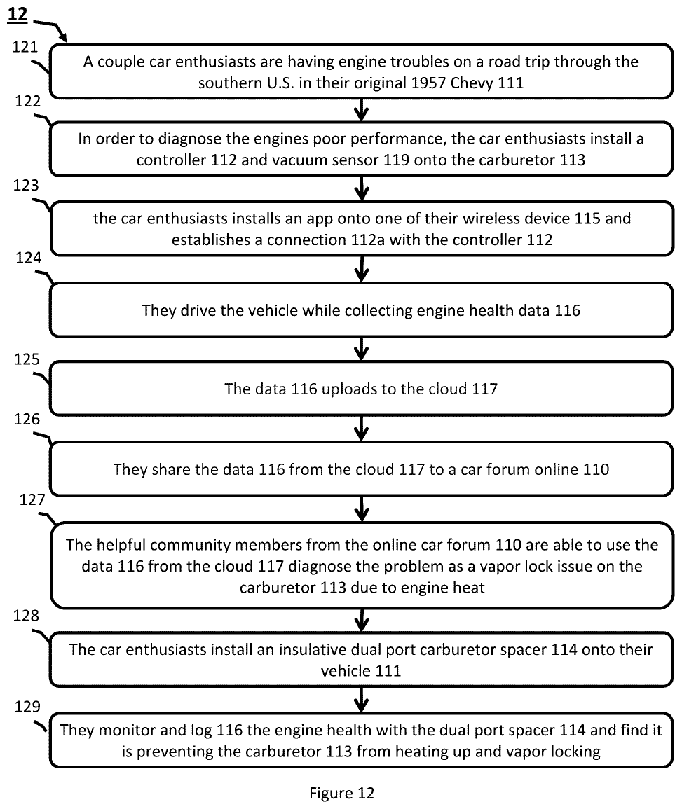

The flow diagram in FIG. 12 illustrates one embodiment of the invention generally designated 120. In FIG. 12, a couple car enthusiasts are having engine troubles on a road trip through the southern U.S. in their original 1957 Chevy 111. In order to diagnose the engines poor performance, the car enthusiasts install a controller 112 and vacuum sensor 119 onto the carburetor 113. Later, the car enthusiasts install an app onto their wireless device 115 and establishes a connection 112a with controller 112. They drive the vehicle while collecting engine health data 116. The data 116 uploads to cloud service 117. They then share the data 116 from cloud service 117 to a car forum online 110. The helpful community members from the online car forum 110 are able to use data 116 from cloud service 117 to diagnose the problem as a vapor lock issue on the carburetor 113 due to engine heat. The car enthusiasts then install an insulative dual port carburetor spacer 114 onto their vehicle 111. They monitor and log 116 the engine health with the dual port spacer 114 and find it is preventing the carburetor 113 from heating up and vapor locking.

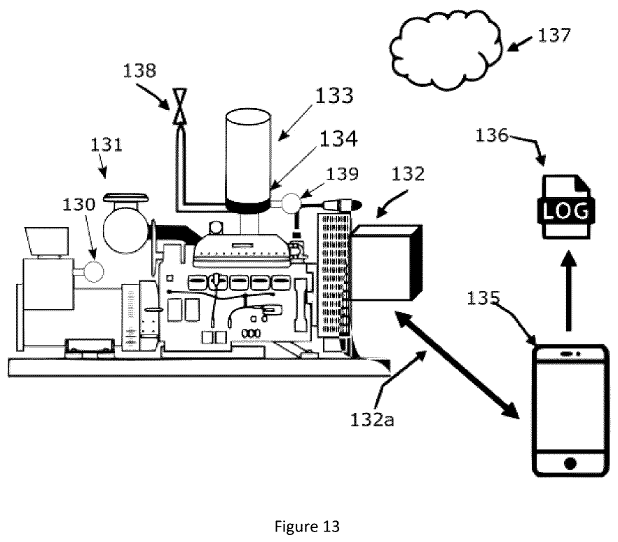

The block diagram of FIG. 13 illustrates more preferred embodiments wherein the system is comprised of a dual port spacer 134 installed between carburetor 133 and the engine of a large generator 131. An idle air control valve 138 connected to one of the ports of the dual port spacer 134. A vacuum sensor 139 is connected to the second port on the dual port spacer 134. A carburetor controller with sensor array 132 is connected to the idle air control valve 138, vacuum sensor 139, fuel quality sensor 130, and engine health sensor array. Carburetor controller 132 also has a wireless communication 132a for communicating with wireless device 135 in order to collect engine data 136 and store the data at a cloud service 137. An application on wireless device 135 allows users to monitor, in real time, all the engine health sensor information.

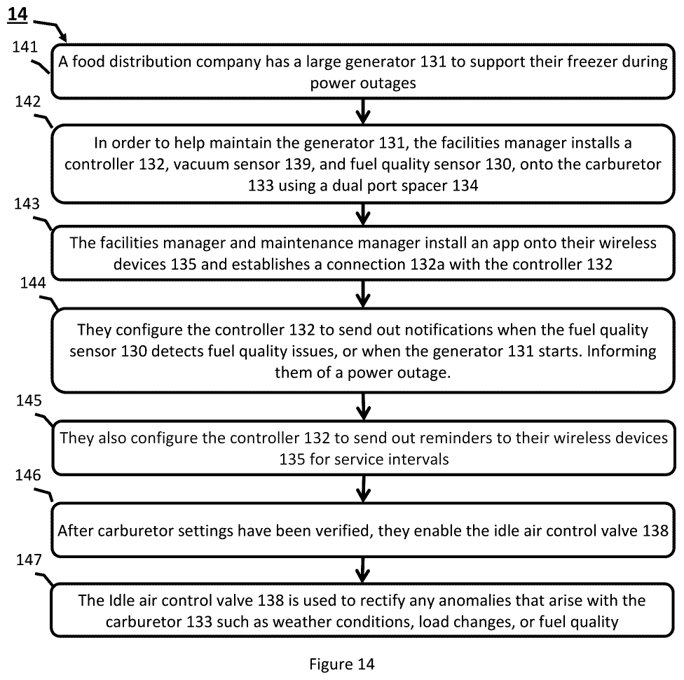

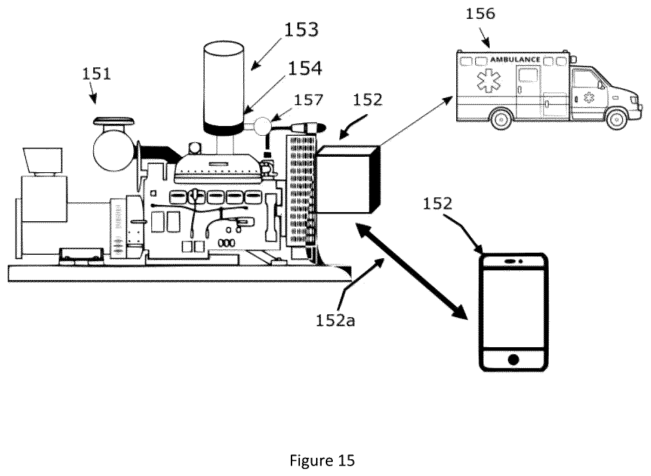

The flow chart in FIG. 14 illustrates one embodiment of the invention generally designated 140. In FIG. 14, A food distribution company has a large generator 131 to support their freezer during power outages. In order to help maintain the generator 131, the facilities manager installs a controller 132, vacuum sensor 139, and fuel quality sensor 130, onto the carburetor 133 using a dual port spacer 134. The facilities manager and maintenance manager install an app onto their wireless devices 135 and establishes a connection 132a with the controller 132. They configure the controller 132 to send out notifications when the fuel quality sensor 130 detects fuel quality issues, or when the generator 131 starts. Informing them of a power outage. They also configure the controller 132 to send out reminders to their wireless devices 135 for service intervals. After carburetor settings have been verified, they enable the idle air control valve 138. The idle air control valve 138 is then used to rectify any anomalies that arise with the carburetor 133 such as weather conditions, load changes, or fuel quality.

The block diagram of FIG. 15 illustrates still more preferred embodiments wherein the system is comprised of a dual port spacer 154 installed between carburetor 153 and the engine of a large generator 151. A vacuum sensor 159 is connected to one port on the dual port spacer 154. A carburetor controller with sensor array 152 is connected to a vacuum sensor 159 and engine health sensor array. Carburetor controller 152 also has a wireless communication 152a for communicating with wireless device 155. An application on wireless device 155 allows users to monitor, in real time, all the engine health sensor information. Controller 152 is also able to notify emergency services 156 in the case of an issue with the generator, or when the power is out.

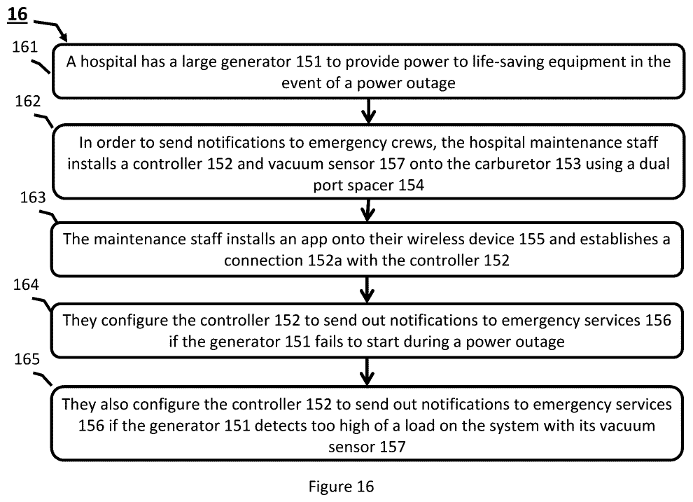

The flow chart in FIG. 16 illustrates one embodiment of the invention generally designated 160. In FIG. 16, A hospital has a large generator 151 to support their life saving equipment during power outages in order to send notifications to emergency crews, the hospital maintenance staff installs a controller 152 and vacuum sensor 157 onto the carburetor 153 using a dual port spacer 154. The maintenance staff installs an app onto their wireless device 155 and establishes a connection 152a with the controller 152. They configure Controller 152 to send out notifications to emergency services 156 if the generator 151 fails to start, detects too high of a load, or any other fault on the generator.

While the invention has been described with respect to a large number of preferred embodiments, it will be appreciated that these are set merely for purposes of example, and that many other embodiments, variations and applications of the invention may be made.

I claim:

1. A system of optimizing carburetor operation comprising:
a carburetor controller;
an air-fuel ratio sensor;
a first communication channel;
a processor;
a power source;
a non-transitory computer-readable memory element;
a second communication channel for transmitting and receiving data;
an external device;
wherein said sensor sample air-fuel ratio in said carburetor; said sensor send said air-fuel ratio information via said first communication channel to said processor; said processor store it in said non-transitory computer-readable memory element; and said processor also send said information to said external device via said second communication channel.

2. The system of optimizing carburetor operation in claim 1, further comprising a pressure sensor for collecting carburetor pressure information.

3. The system of optimizing carburetor operation in claim 1, further comprising a pressure valve for controlling carburetor pressure level.

4. The system of optimizing carburetor operation in claim 1, further comprising a tachometer for collecting revolution information.

5. The external device in claim 1, further comprising a screen for displaying said information.

6. The system of optimizing carburetor operation in claim 1, further comprising a carburetor spacer with two vacuum ports that are both connected to the main body on the manifold.

7. An apparatus comprising:
carburetor spacer with two vacuum ports;
wherein both ports connected to the intake chamber on the manifold.

8. The carburetor spacer apparatus in claim 7, further comprising a heat insulation for keeping the engine heat away from the carburetor.

9. The vacuum ports in claim 7, further comprising directional opening for creating an air swirl for better atomization of the fuel.

10. An apparatus for optimizing carburetor operation, comprising:
a carburetor controller;
an air-fuel ratio sensor;
first communication channel;
a processor;
a power source;
a non-transitory computer-readable memory element;
a second communication channel for transmitting and receiving data;
an external device;
wherein said air-fuel ratio sensor samples the air-fuel ratio in the carburetor; said air-fuel ratio sensor sends the air-fuel ratio information via said first communication channel to said processor; said processor stores the air-fuel ratio information in said non-transitory computer-readable memory element; and said processor also sends said air-fuel ratio information to said external device via said second communication channel.

11. The apparatus of claim 10, further comprising a pressure sensor for collecting carburetor pressure information.

12. The apparatus of claim 10, further comprising a pressure valve for controlling the carburetor pressure level.

13. The apparatus of claim 10, further comprising a tachometer for collecting revolution information.

14. The apparatus of claim 10, wherein the external device further comprises a screen for displaying the air-fuel ratio information.

15. The apparatus of claim 10, further comprising a carburetor spacer with two vacuum ports that are both connected to the main body on the manifold.
